(19) United States
(12) Patent Application Publication
(10) Pub. No.: US 2014/0032122 A1
(43) Pub. Date: Jan. 30, 2014

(54) GENE-WIDE SIGNIFICANCE (GWIS) TEST: NOVEL GENE-BASED METHODS FOR THE IDENTIFICATION OF GENETIC ASSOCIATIONS HAVING MULTIPLE INDEPENDENT EFFECTS

(71) Applicant: The Johns Hopkins University, Baltimore, MD (US)

(72) Inventors: Joel Bader, Baltimore, MD (US); Hailiang Huang, Silver Spring, MD (US); Daniel E. Arking, Baltimore, MD (US); Pritam Chanda, Baltimore, MD (US)

(73) Assignee: The Johns Hopkins University, Baltimore, MD (US)

(21) Appl. No.: 13/953,403

(22) Filed: Jul. 29, 2013

Related U.S. Application Data
(60) Provisional application No. 61/676,382, filed on Jul. 27, 2012.

(51) Int. Cl. G06F 19/18

(52) U.S. Cl. CPC G06F 19/18
USPC 702/19

(57) ABSTRACT

A novel set of methods for gene-based tests of association are provided. By gathering multiple independent effects into a single test, GWiS has greater power than conventional tests to identify genes with multiple causal variants. GWiS also retains power for low-frequency minor alleles that are increasingly important for personal genetics, a feature not shared by other multi-SNP tests. The methods of the present invention can be combined with conventional computing platforms to provide a new analytical tool for analyzing genes which are linked to multiple traits.

### REFERENCE TO RELATED APPLICATIONS

This application claims the benefit of U.S. Provisional Patent Application No. 61/676,382, filed on Jul. 27, 2012, which is hereby incorporated by reference for all purposes as if fully set forth herein.

### STATEMENT OF GOVERNMENTAL INTEREST

This invention was made with government support under grant no. HG006120 awarded by the NIH. The government has certain rights in the invention.

### BACKGROUND OF THE INVENTION

Traditional single-SNP genome-wide association studies (GWAS) methods have been remarkably successful in identifying genetic associations, including those for various ECG parameters in recent studies of PR interval (the beginning of the P wave to the beginning of the QRS interval), QRS interval (depolarization of both ventricles), and QT interval (the start of the Q wave to the end of the T wave). Much of this success has relied upon increasing sample size through meta-analyses across multiple cohorts, rather than through the use of novel analytical methods to increase power.

One analytical approach, gene-based tests proposed during the initial development of GWAS, has natural appeal. First, variations in protein-coding and adjacent regulatory regions are more likely to have functional relevance. Second, gene-based tests allow for direct comparison between different populations, despite the potential for different linkage disequilibrium (LD) patterns and/or functional alleles. Third, these analyses can account for multiple independent functional variants within a gene, with the potential to greatly increase the power to identify disease/trait-associated genes.

Despite these appealing properties, gene-based and related multi-marker association tests have generally under-performed single-locus tests when assessed with real data. A general drawback of methods that attempt to exploit the structure of LD to reduce the number of tests, for example through principal component analysis, is the loss of power to detect low-frequency alleles. Methods that consider multiple independent effects often require that the number of effects be pre-specified, which loses power when the tested and true model are different.

Multi-locus tests often have the additional practical drawback of being highly CPU and memory intensive. Several methods use Bayesian statistics to drive a brute-force sum or Monte Carlo sample over models, but again often restrict the search to one or two-marker associations. In general, the computational costs have made these approaches infeasible for genome-wide applications.

Currently there are no standard criteria for establishing the genome-wide significance of a weak second association in a gene whose strongest effect is genome-wide significant.

### SUMMARY OF THE INVENTION

The Gene-Wide Significance (GWiS) test methods of the present invention address these problems by performing model selection simultaneously with parameter estimation and significance testing in a computational framework that is feasible for genome-wide SNP data. Model selection, in accordance with the methods of the present invention, defined as identifying the best tagging SNP for each independent effect within a gene, uses the Bayesian model likelihood as the test statistic (J. American Statistical Assn., 88: 881-889 (1993); Genetics, 159: 1351-64 (2001); Genetics, 167: 989-99 (2004)).

The methods of the present invention use gene regions to impose a structured search through locally optimal models, which is computationally efficient and matches the biological intuition that the presence of one causal variant within a gene increases the likelihood of additional causal effects. The models of the present invention are penalized based on the effective number of independent SNPs within a gene and the number of SNPs in the model, akin to a multiple-testing correction. The Schwarzian Bayesian Information Criterion corrects for the difference between the full model likelihood and the easily computed maximum likelihood estimate (Annal. Statistics, 6: 461-464 (1978)). The methods of the present invention have greater power than current methods for genome-wide association studies and provide a principled alternative to ad hoc follow-up analyses to identify additional independent association signals in loci with genome-wide significant primary associations.

GWiS provides a new capability to estimate the number of independent effects as part of primary GWAS data analysis. Demonstrated effectiveness on real data may lead to more widespread use of this type of analysis. A study of cardiovascular phenotypes relevant to sudden cardiac death and atrial fibrillation using GWiS found that 35 to 50% of all known loci contain multiple independent genetic effects.

The novel methods described herein include a prior on models designed to be unaffected by SNP density, in particular by the number of SNPs that are correlated with a causal variant. The priors on regression parameters are essentially uniform, with the benefit of eliminating any user-adjustable parameters. A theoretical drawback is that the priors are improper. Theoretical concerns are mitigated, however, because improper priors pose no challenge for model selection, and our permutation procedure ensures uniform p-values under the null.

GWiS minimizes computation by evaluating only the locally optimal models of increasing size in a greedy forward search. The present invention demonstrates that the approximations used by GWiS provide greater computational efficiency than approximations used in previous Bayesian frameworks, with nearly no loss of statistical power. GWiS currently calculates p-values, rather than Bayesian evidence provided by other Bayesian methods.

The GWiS framework, using gene annotations to structure Bayesian model selection, may be applied to case-control data by encoding phenotypes as 1 (case) versus 0 (control), a reasonable approach when effects are small. More fundamental extensions to logistic regression, Transmission Disequilibrium Tests (TDTs), and other tests and designs should be possible and may yield further improvements. Moreover, similar gene-based structured searches can be applied to genetic models to include explicit interaction terms. The Bayesian format also permits incorporation of prior information about the possible functional effects of SNPs, and disease linkage. Finally, the gene-based p-values of the inventive methods provide a natural entry to gene annotations and pathway-based gene set enrichment analysis.

Therefore, in accordance with an embodiment, the present invention provides a method for identifying one or more single nucleotide polymorphisms (SNP) associated with one or more phenotypic traits of interest in a subject comprising: a) identifying one or more phenotypic traits of interest; b) mapping known SNPs to the genes in the genome, wherein SNPs located within 20 kb of the transcribed genomic loci are included; c) calculating for each gene, the GWiS test statistic (greedy forward selection from all single SNPs and pairs) using the GWiS function; d) calculating for each gene, the null distribution of the test statistics by permutation tests, using the GWiS function; e) calculating for each gene, GWiS P-value from the null distribution; f) performing hierarchical analysis of genetic loci identified in b) comprising: 1) identifying all gene loci with GWIS p-value≦0.01; 2) using transitive clustering to merge into a locus, all gene loci whose transcript boundaries are within 200 kb; 3) calculating the GWIS statistic on the merged locus using the GWiS function; 4) identifying the SNPs selected by 3) wherein i) if the genes are located at either end of the locus of 2) and have no GWiS SNPs, delete these genes from the locus; 5) repeat steps 3) and 4) until there are no further genes which can be deleted; 6) if only 1 gene loci remains, identifying it with its original p-value from step e); otherwise; if more than 1 gene loci remains, use a permutation test to calculate the p-value for the merged locus of 3); and 7) assigning the merged gene locus a p-value equal to the minimum p-values of the individual genes (from e) and the p-value from the merged locus' own permutation (from 6) and retain the entire region as an associated gene locus.

In accordance with another embodiment, the present invention provides a database containing one or more SNPs identified using the above method.

In accordance with a further embodiment, the present invention provides a computer system comprising: a relational database having records containing a) information about one or more SNPs identified using the method described above; b) information identifying known SNPs to the genes known to be associated with the one or more phenotypic traits of interest; and c) a user interface allowing a user to selectively access the information contained in the records.

In accordance with another embodiment, the present invention provides a computer program product comprising: a computer-usable medium having computer-readable program code embodied thereon relating to generating a relational database having records containing a) information about one or more SNPs identified using the method described above; b information identifying known SNPs to the genes known to be associated with the one or more phenotypic traits of interest; wherein one or more SNPs in a) is determined based b) and the method described above.

In accordance with yet another embodiment, the present invention provides A computerized method for identifying one or more single nucleotide polymorphisms (SNP) associated with one or more phenotypic traits of interest in a subject comprising: a) receiving, by a computer, the identification of one or more phenotypic traits of interest; b) mapping by a computer, known SNPs to the genes in the genome, wherein SNPs located within 20 kb of the transcribed genomic loci are included; c) computing, by the computer, for each gene, the GWiS test statistic (greedy forward selection from all single SNPs and pairs) using the GWiS function; d) computing, by the computer, for each gene, the null distribution of the test statistics by permutation tests, using the GWiS function; e) computing, by the computer, for each gene, GWiS p-value from the null distribution; f) computing, by the computer, hierarchical analysis of genetic loci identified in b) comprising: 1) identifying, by the computer, all gene loci with GWiS p-value≦0.01; 2) computing, by the computer, using transitive clustering to merge into a locus, all gene loci whose transcript boundaries are within 200 kb; 3) computing, by the computer, the GWiS statistic on the merged locus using the GWiS function; 4) identifying, by the computer, the SNPs selected by 3) wherein i) if the genes are located at either end of the locus of 2) and have no GWiS SNPs, delete these genes from the locus; 5) repeat steps 3) and 4) until there are no further genes which can be deleted; 6) if only 1 gene remains in a locus, identifying it with its original p-value from step e); otherwise; if more than 1 gene loci remains, use a permutation test to calculate the p-value for the merged locus of 3); and 7) assigning, by the computer, the merged gene locus a p-value equal to the minimum p-values of the individual genes (from e) and the p-value from the merged locus' own permutation (from 6) and retain the entire region as an associated gene locus.

In accordance with still a further embodiment, the present invention provides A computerized system identifying one or more single nucleotide polymorphisms (SNP) associated with one or more phenotypic traits of interest in a subject comprising: a) a server and a client connected by a network; b) an application connected to the server and/or the client by the network, the application configured for: c) receiving, by a computer, the identification of one or more phenotypic traits of interest; d) mapping by a computer, known SNPs to the genes, wherein SNPs located within 20 kb of the transcribed genomic loci are included; e) computing, by the computer, for each gene, the GWiS test statistic (greedy forward selection from all single SNPs and pairs) using the GWiS function; f) computing, by the computer, for each gene, the null distribution of the test statistics by permutation tests, using the GWiS function; g) computing, by the computer, for each gene, GWiS p-value from the null distribution; h) computing, by the computer, hierarchical analysis of genetic loci identified in b) comprising: 1) identifying, by the computer, all gene loci with GWiS p-value≦0.01; 2) computing, by the computer, using transitive clustering to merge into a locus, all gene loci whose transcript boundaries are within 200 kb; 3) computing, by the computer, the GWIS statistic on the merged locus using the GWiS function; 4) identifying, by the computer, the SNPs selected by 3) wherein i) if the genes are located at either end of the locus of 2) and have no GWiS SNPs, delete these genes from the locus; 5) repeat steps 3) and 4) until there are no further genes which can be deleted; 6) if only 1 gene remains in a locus, identifying it with its original p-value from step e); otherwise; if more than 1 gene remains in a locus, use a permutation test to calculate the p-value for the merged locus of 3); and 7) assigning, by the computer, the merged gene locus a p-value equal to the minimum p-values of the individual genes (from e) and the p-value from the merged locus' own permutation (from 6) and retain the entire region as an associated gene locus.

### BRIEF DESCRIPTION OF THE DRAWINGS

FIG. 1 depicts the estimated power at genome-wide significance for simulated data. Power estimates for GWiS (black), minSNP-P (blue), BIMBAM (dashed blue), VEGAS (green), and LASSO (red) are shown for 0.007 population variance explained by a gene. Genes were selected at random from Chr 1; genotypes were taken from ARIC; and phenotypes were simulated according to known models with up to 8 causal variants with independent effects. (1A) Power decreases as total variance is diluted over an increasing number of causal variants. (1B) Power estimates with 95% confidence intervals are shown as a function of minor allele frequency (MAF) for the simulations from panel (a) with a single independent effect. GWiS, minSNP, minSNP-P, and BIMBAM are robust to low minor allele frequency, whereas VEGAS and LASSO lose power.

FIG. 2 depicts the estimated power at genome-wide significance for genotypes simulated without LD. Simulation tests were performed for true models in which a single gene housed one to eight independent causal variants. Genotypes were simulated with 20 SNPs per gene, no LD between SNPs, and minor allele frequencies selected uniformly between 0.05 and 0.5. Power estimates are provided for VEGAS (green), GWiS (black), minSNP-P (blue), BimBam (blue dashed), and LASSO (red). While VEGAS performs well in the absence of LD, its performance degrades under realistic LD. Genetic models for quantitative traits were simulated with no linkage disequilibrium between SNPs using the simulate-qt option of PLINK. Genes were simulated with 20 SNPs and minor allele frequencies selected uniformly between 0.05 and 0.5. Genotypes were coded as allele dosages from 0 to 2. The power of a standard regression test for additive effects depends on the population variance explained, V=2p(1−p)b² for a single variant with allele frequency P and regression coefficient (or effect size) b. We performed simulations holding V constant and sampling different allele frequencies, adjusting the effect size to obtain the desired variance explained, V=0.007. For each choice of the true model size K from 1 to 8, we averaged over 1000 simulations each with 8000 individuals. In each simulation, we randomly selected K SNPs to be “causal” SNPs and distributed the variance equally across the causal SNPs, with each SNP contributing variance V/K. The resulting model for the phenotype of an individual with genotype row-vector X for the causal SNPs is Y=(X−μ)·b+u\sqrt{1−V}, where μ is the true population average of X, b is the column-vector of SNP effects, and u is drawn from a standard normal distribution. The resulting value for the component of b for a causal SNP with minor allele frequency P is b=±\sqrt{(V/K)/2p(1−p)}. The power was calculated as (number of genes that are genome-wide significant)/1000, and the error of the estimate was calculated using 95% exact binomial confidence intervals. The p-value thresholds for genome-wide significance came from genome-wide permutations of actual data for GWiS, BimBam, minSNP-P and VEGAS. For LASSO, however, the selection index threshold from the genome-wide permutations may not be appropriate for simulations without LD. We therefore used a slightly different approach for LASSO. A null distribution of the selection index through permutations was calculated, and then this null distribution was used to convert the selection index to a gene-based p-value. The p-value was then compared to the most lenient gene-based threshold of the other methods, 3×10⁻⁶ from minSNP-P.

FIG. 3 depicts model size estimation. The ability to recover the known model size was evaluated for GWiS (3A and 3B) and LASSO (3C and 3D). The power to detect a single SNP was set to be 10% (3A and 3C) and 80% (3B and 3D). In separate tests, the causal SNPs were either retained in (black) or removed from (red) the genotype data.

FIG. 4 shows the number of SNPs and effective number of tests per gene. The number of SNPs and effective tests per gene are displayed as a density plot for (4a) chromosome 1 and (4b) the autosomal genome. While on average genes have 70 SNPs and 9 tests, large genes can have over 1000 SNPs and 100 tests.

FIG. 5 depicts the recovery of known positive associations at genome-wide significance. Of 38 known positives, GWiS identified 6 at genome-wide significance with no false positives. Univariate methods (minSNP and minSNP-P) and VEGAS identified a subset of 4 entirely contained by GWiS, and LASSO identified a smaller subset of 2.

FIG. 6 is a table showing the recovery of known associations.

FIG. 7 is a graph showing precision-recall curves for recovery of known associations. Precision and recall for recovery of 38 known associations are shown for GWiS (black), minSNP (thin blue), minSNP-P (thick blue), BIMBAM (dashed blue), LASSO (red), and VEGAS (green). Ranking is by p-value for GWiS, minSNP, minSNP-P, and VEGAS, and by Selection Index for LASSO. The tails of the curves for GWiS and LASSO are truncated when remaining loci have no SNPs entered into models, which occurs close to 50% recall. Triangles indicated the last genome-wide significant finding from each method.

FIG. 8 is a graph depicting that multiple weak effects identified as genome-wide significant. GWiS correctly identified the SCN5A-SCN10A locus as genome-wide significant with four independent effects, even though the strongest single effect has a p-value 100× worse than the genome-wide significance threshold indicated as a dashed line. No other method was able to identify this locus as genome-wide significant. The SNPs selected by GWiS are represented as large, colored diamonds, and SNPs in LD with these four are colored in lighter shades. The light blue trace indicates recombination hotspots.

FIG. 9 is a graph of the distribution of the number of independent effects in ECG loci. Of 38 known positive loci, GWiS identified 20 loci, and 7 of these contain multiple independent effects.

FIG. 10 is a table showing the minimal memory requirement and the total CPU time to finish one genome-wide study are reported for both a null (shuffled) trait and the real trait. Benchmarks were obtained from AMD Operon 2.3 GHz or similar processors. The memory and CPU requirements include the model selection and the calculation of the gene-based p-values (or selection index). Costs for the genome-wide permutations to establish genome-wide significance thresholds are not included in the estimates. LASSO consumes the least resources because it pre-filters the SNPs (only uses SNPs having p-values <0.001) and does not require permutations to calculate the selection index. The real phenotypes require more CPU time because more permutations are required to calculate genome-wide significant p-values for true associations.

### DETAILED DESCRIPTION OF THE INVENTION

In accordance with an embodiment, the present invention provides novel testing methods motivated by the biological hypothesis that a single gene may contain multiple variants that contribute independently to a trait. Applied to simulated phenotypes with real genotypes, the inventive method, Gene-Wide Significance (GWiS), has better power to identify true associations than traditional univariate methods, previous Bayesian methods, popular L1 regularized (LASSO) multivariate regression, and other approaches. The GWiS test of the present invention retains power for low-frequency alleles that are increasingly important for personal genetics, and it is the only method tested that accurately estimates the number of independent effects within a gene. When applied to human data for multiple ECG traits, GWiS test of the present invention identifies more genome-wide significant loci (verified by meta-analyses of much larger populations) than any other method. It is estimated that 35%-50% of ECG trait loci are likely to have multiple independent effects, suggesting that the methods of the present invention will reveal previously unidentified associations when applied to existing data and will improve power for future association studies.

GWiS has been shown to have improved power in finding genomic regions that are associated with complex traits. For example, applying GWiS to the Electrocardiographic traits, including QT interval, QRS complex and PR interval, has identified 6 genomic loci that are genome-wide significantly associated with the traits, while only 4 loci had been identified using the existing single-SNP method. Similar improvements have been observed for other complex traits, such as blood traits including HGB and MCV, and schizophrenia.

Due to the popular demand of GWiS from the community, there have been ongoing efforts to integrate GWiS into PLINK (Am. J. Hum. Gen. 81(3):559-75 (2007)), the most widely used analysis tool in GWAS, as well as into a gene based association analysis toolkit (GBAAT) in development.

In accordance with an embodiment, the present invention provides a method for identifying one or more single nucleotide polymorphisms (SNP) associated with one or more phenotypic traits of interest in a subject comprising: a) identifying one or more phenotypic traits of interest; b) mapping known SNPs to the genes in the genome, wherein SNPs located within 20 kb of the transcribed genomic loci are included; c) calculating for each gene, the GWiS test statistic (greedy forward selection from all single SNPs and pairs) using the GWiS function; d) calculating for each gene, the null distribution of the test statistics by permutation tests, using the GWiS function; e) calculating for each gene, GWiS p-value from the null distribution; f) performing hierarchical analysis of genetic loci identified in b) comprising: 1) identifying all gene loci with GWiS p-value ≦0.01; 2) using transitive clustering to merge into a locus, all gene loci whose transcript boundaries are within 200 kb; 3) calculating the GWiS statistic on the merged locus using the GWiS function; 4) identifying the SNPs selected by 3) wherein i) if the genes are located at either end of the locus of 2) and have no GWiS SNPs, delete these genes from the locus; 5) repeat steps 3) and 4) until there are no further genes which can be deleted; 6) if only 1 gene remains in a locus, identifying it with its original p-value from step e); otherwise; if more than 1 gene remains in a locus, use a permutation test to calculate the p-value for the merged locus of 3); and 7) assigning the merged gene locus a p-value equal to the minimum p-values of the individual genes (from e) and the p-value from the merged locus' own permutation (from 6) and retain the entire region as an associated gene locus.

It will be understood by those of ordinary skill in the art that the phenotypic trait can be any phenotype which is already known to be associated with at least one gene loci. In an embodiment, the phenotypic trait which can be studied using GWiS is a trait associated with an organ system of a mammal.

In another embodiment of the present invention, the phenotypic trait which can be studied using GWiS is a trait associated a disease or condition. Almost any disease or condition is known to be associated with at least one gene loci. As such, in a further embodiment of the present invention the phenotypic trait which can be studied using GWiS is a disease or condition such as, for example, cardiovascular disease, cancer, diabetes, stroke, neurological disease, enzymatic deficiencies, Alzheimer's, Parkinson's, galactosemia, thalassemias, neuropathy, immune system disorders, amyotrophic lateral sclerosis, hypercholestermia,

It will be understood by those of ordinary skill in the art that the one or more SNPs identified can be used to generate a SNP database. The database can be stored on computer readable media in a computer. The database can also be stored remotely over a network on a server and is accessible with at least one client computer attached to the network. The database is populated with information on one or more SNPs identified using the GWiS methods described herein.

In accordance with an embodiment, the present invention provides at least one client computer which can be connected to at least one server computer over a network. At least one application can be connected to the at least one client computer and/or the at least one server computer over the network. The at least one application can comprise at least one GWiS determination module; at least one SNP genotype database, and at least one GWiS locus database. It should be noted that the SNP genotype database and GWiS locus database can reside on the application, or outside the application. In addition, the application can reside on the client computer and/or the server computer. Furthermore, many additional databases and modules can be utilized by the application, and can reside on the application or outside the application.

The at least one GWiS determination module can determine one or more single nucleotide polymorphisms (SNP) associated with one or more phenotypic traits of interest in a subject comprising: a) receiving, by a computer, the identification of one or more phenotypic traits of interest; b) mapping by a computer, known SNPs to the genes in the genome wherein SNPs located within 20 kb of the transcribed genomic loci are included; c) computing, by the computer, for each gene, the GWiS test statistic (greedy forward selection from all single SNPs and pairs) using the GWiS function; d) computing, by the computer, for each gene, the null distribution of the test statistics by permutation tests, using the GWiS function; e) computing, by the computer, for each gene, GWiS p-value from the null distribution; f) computing, by the computer, hierarchical analysis of genetic loci identified in b) comprising: 1) identifying, by the computer, all gene loci with GWiS p-value ≦0.01; 2) computing, by the computer, using transitive clustering to merge into a locus, all gene loci whose transcript boundaries are within 200 kb; 3) computing, by the computer, the GWiS statistic on the merged locus using the GWiS function; 4) identifying, by the computer, the SNPs selected by 3) wherein i) if the genes are located at either end of the locus of 2) and have no GWiS SNPs, delete these genes from the locus; 5) repeat steps 3) and 4) until there are no further genes which can be deleted; 6) if only 1 gene remains in a locus, identifying it with its original p-value from step e); otherwise; if more than 1 gene remains in a locus, use a permutation test to calculate the p-value for the merged locus of 3); and 7) assigning, by the computer, the merged gene locus a p-value equal to the minimum p-values of the individual genes (from e) and the p-value from the merged locus' own permutation (from 6) and retain the entire region as an associated gene locus.

It will be understood by those of ordinary skill in the art that the inventive methods identified herein are useful for characterizing phenotypic traits of many diseases. Examples of such diseases, include, but are not limited to, diseases or conditions such as cardiovascular disease, cancer, diabetes, stroke, neurological disease, enzymatic deficiencies, alzheimers, parkinsons, galactosemia, thalassemias, neuropathy, immune system disorders, amyotrophic lateral sclerosis, hypercholestermia, autism, schizophrenia, Crohn's disease, and ulcerative colitis

### EXAMPLES

Known positives. Known positive associations are taken from published genome-wide significant SNP associations (p-value <5×10⁻⁸) described above. Genes within 200 kb of any genome-wide significant SNP are scored as known positives. Finally, genes within 200 kb that are both positive are merged into a single known positive locus to avoid over-counting.

Study cohort. The ARIC study includes 15,792 men and women from four communities in the U.S. (Jackson, Miss.; Forsyth County, North Carolina; Washington County, Maryland; suburbs of Minneapolis, Minn.) enrolled in 1987-89 and prospectively followed (Am. J. Epidemiol., 129: 687-702 (1989). ECGs were recorded using MAC PC ECG machines (Marquette Electronics, Milwaukee, Wis.) and initially processed by the Dalhousie ECG program in a central laboratory at the EPICORE Center (University of Alberta, Edmonton, Alberta, Canada) but during later phases of the study using the GE Marquette 12-SL program (2001 version) (GE Marquette, Milwaukee, Wis.) at the EPICARE Center (Wake Forest University, Winston-Salem, North Carolina). All ECGs were visually inspected for technical errors and inadequate quality. Genotype data sets were cleaned initially by discarding SNPs with Hardy-Weinberg equilibrium violations at p<0.0000 minor allele frequencies <0.01, or call rates <0.95. Imputation with HapMap CEU reference panel version 22 was then performed, and all imputed SNPs were retained for analysis, included imputed SNPs with minor-allele frequencies as low as 0.001. These cleaned data sets contributed to the meta-analysis to yield the known positives, and full descriptions of phenotype and sample data cleaning are available elsewhere. Regional association plots were generated using a modified version of “make.fancy.locus.plot” (Science, 316: 1331-1336 (2007).

Conventional multiple regression. The phenotype vector Y for N individuals is an N×l vector of trait values. The genotype matrix X has N rows and P columns, one for each of P genotyped markers assumed to be biallelic SNPs. For simplicity, the vector Y and each column of X are standardized to have zero mean. A standard regression model estimates the phenotype vector as Y=Xb+e, where b is a vector of regression coefficients and e is a vector of residuals assumed to be independent and normally distributed with mean 0 and variance σ². The log probability of the phenotypes given these parameters is

$$log Pr ( Y \vert b , {σ}^{2} , X ) = - \frac{1}{2} \{ N ln ( 2 π ) + N ln ( {σ}^{2} ) + \frac{{\vert Y - Xb \vert}^{2}}{{σ}^{2}} \} . \qquad ( 1 )$$

The maximum likelihood estimators (MLEs) are \hat{σ}²=|Y−Xb|²/N and \hat{b}=(X′X)⁻¹X′Y, where X′denotes the transpose of X. The total sum-of-squares (SST) is |Y|², and the sum-of-squares of the model (SSM) is |Ŷ|²=Y′X(X′X)⁻¹X′Y. The sum-of-squares of the errors or residuals (SSE) is

SSE=SST−SSM=|Y−X\hat{b}|²=|Y|²−|Ŷ|² (2)

A conventional multiple regression approach uses the F-statistic to decide whether adding a new SNP improves the model significantly,

$$F = \frac{SSM / K}{SSE / ( N - K - 1 )} \qquad ( 3 )$$

for a model with K SNPs, distributed as F(K,N−K−1) under the null. This approach fails, however, when the best K SNPs are selected from the much larger number of M total SNPs, because the F statistic does not account for the selection process.

Bayesian model selection. A model M is defined as the subset of K SNPs in a gene with P total SNPs that are permitted to have non-zero regression coefficients. For each gene, GWiS attempts to find the subset that maximizes the model probability Pr(M|Y,X), where each of the P columns of X corresponds to a SNP assigned to the gene. In the absence of association, the null model with K=0 usually maximizes the probability, indicating no association. When a model with K>0 maximizes the probability, an association is possible, and permutation tests provide a p-value. According to Bayes rule,

Pr(M|Y,X)=Pr(Y|M,X)Pr(M)/Pr(Y) (4)

The factor Pr(Y) is model-independent and can be ignored.

The prior probability of the model, Pr(M), assumes that each of the P SNPs within the gene has an identical probability of being associated with the trait. This probability, denoted f, is unknown, and is integrated out with a uniform prior. The prior is also designed to make the model probability insensitive to SNP density: it should be unaffected if an existing SNP is replicated to create a new SNP marker with identical genotypes. We do this by replacing the number of SNPs within a gene with an effective number of tests, T, calculated from the local LD within a gene. Correlations between SNPs make the effective number of tests smaller than the number of SNPs. The model prior based on the effective number of tests is:

Pr(M)=∫₀¹f^{K}(1−f)^{T-K}df≡Beta(K+1,T−K+1) (5)

or K!(T−K)!/(T+1)! for integer values. As the effective number of tests, T, whose calculation is described below, is generally non-integer, we use the standard Beta function rather than factorials.

The remaining factor in Eq. 4 is

Pr(Y|M,X)=(AB^{K})⁻¹∫₀^{A}dτ∫_{-B/2}^{B/2}db(τ/2π)^{N/2}exp[−(τ/2)|Y−Xb|²] (6).

The integration limits and prefactor 1/AB^{K} ensure normalization. We assume that these limits are sufficiently large to permit a steepest descents approximation as in Schwarzian BIC model selection. First, assuming that the genotypes are centered, the genotype covariance matrix is ΣΣX′X/N, where indicates matrix transpose as before, and diagonal elements Σₖₖ≈2pₖ(1−pₖ) for SNP k with allele frequency pₖ. Provided that B is much greater than each component of \hat{b}=(X′X)⁻¹X′Y, the integral over b is approximately

Pr(Y|M,X)=(AB^{K}detΣ^{1/2})⁻¹N^{-K/2}∫₀^{A}dΣ(τ/2π)^{(N-K)/2}exp[−(τ/2)SSE] (7)

where the sum-squared-error SSE is |Y−X\hat{b}|². Provided that the limit A is much greater than the maximum likelihood value \tilde{τ}=(N−K)/SSE≡1\tilde{σ}², the integral over can be approximated as

∫₀^{A}dτ(τ/2π)^{(N-K)/2}exp[−(τ/2)SSE]≈(2/SSE)^{1+(N-K)/2}(1/2π)^{(N-K)/2}Γ[1+(N−K)/2] (8)

where Γ(x) is the standard Gamma function. To avoid the cost of Gamma function evaluations, we instead use the steepest descents approximation,

∫₀^{A}dτ(τ/2π)^{(N-K)/2}exp[−(τ/2)SSE]≈[2π/(N−K)\tilde{σ}⁴]^{1/2}(1/2π\tilde{σ}²)^{(N-K)/2}e^{-(N-K)/2} (9)

The log-likelihood is then

ln Pr(Y|M,X)=−[(N−K)/2][1+ ln(2π\tilde{σ}²)]−(K/2)ln N−ln(AB^{K}detΣ^{1/2})+(1/2)ln [2π/(N−K)\tilde{σ}⁴] (10)

As in the BIC approximation, we retain only terms that depend on the model and are of order ln N or greater. Thus we replace N−K by N, and \hat{σ}²≈\hat{σ}². For historical reasons, we also included a factor of (2π)^{K/2} in the prior for model size, to yield the asymptotic approximation

ln Pr(Y|M,X)≈−(N/2)[1+ ln(2π\hat{σ}²)]−(K/2)ln(N/2π) (11)

The strategy of GWiS is therefore to find the model that maximizes the objective function

Pr(M|Y,X)≈−(N/2)[1+ ln(2π\hat{σ}²)]−(K/2)ln(N/2π)+ ln Beta(K+1,T−K+1) (12)

As used herein, Equation (12) above will be referred to as the “GWiS function.”

The terms involving K provide a Bayesian penalty for model performance, but also make this an NP-hard optimization problem. We have adopted two efficient deterministic heuristics for approximate optimization. First is a greedy forward search, essentially Bayesian regularized forward regression, in which the SNP giving the maximal increase to the model likelihood is added to the model sequentially until all remaining SNPs decrease the likelihood. The second is a similar heuristic, except that the initial model searches through all subsets of 2 SNPs or 3 SNPs. We adopted this subset search to permit the possibility that all K=1 models are worse than the K=0 null, whereas a more complex model with K=2 or 3 has higher score. In practice, all associations identified by subset selection were also identified by greedy forward search. We therefore used the greedy forward search for computational efficiency.

The GWiS methods of the present invention are designed to select a single model for each gene. An alternative related approach would be to test for the posterior probability of the null model, Pr(noSNPs|data), against all other models, Pr(1SNP|data)₊Pr(2SNPs|data)₊Pr(3SNPs|data)_{+ . . .} , using our model selection procedure either to choose the locally best model of each size or to include multiple models (which could suffer from a systematic bias favoring SNPs in large LD blocks). This is in fact the strategy of BIMBAM, which attempts to systematically evaluate all terms up to a given model size. Unfortunately, the number of terms increases exponentially fast with model size, and the brute-force approach does not scale to genome-wide applications. Monte Carlo searches over models have also been difficult to apply genome-wide. The present work suggests that approximations that limit the search for fixed model size can be accurate, and further that the probabilities of models that are too large are expected to decrease exponentially fast, permitting the sum to be pruned and truncated. It has been observed in practice that the model with the most likely value of K dominates the sum, and similarly for BIMBAM that the single SNP with the best Bayes Factor dominates the sum-of-Bayes-Factors test statistic. These results show that the results of a more computationally expensive sum over all models would be largely consistent with the results of GWiS method. Furthermore, the Bayes Factor for the most likely model could provide a proxy for the Bayesian evidence.

Effective number of tests. The effective number of tests is an established concept in GWAS to provide a multiple-testing correction for correlated markers. While the exact correction can be established by permutation tests, faster approximate methods can perform well. While we use a fast procedure, a final permutation test ensures that p-values are uniform under the null.

The method adopted in the GWiS of the present invention is based on multiple linear regression of SNPs on SNPs. The genotype vector xᵢ for each SNP i is standardized to have zero mean. Correlations between all pairs of SNPs i and j are initialized as Cᵢⱼ=xᵢ′xⱼ/\sqrt{|xᵢ∥xⱼ|}. Each SNPs weight wᵢ is initialized to 1, and the number of effective tests T is initialized to 0. The SNP i with maximum weight is identified, and the following updates are executed:

T←T+wᵢwⱼ←max(wⱼ−Cⱼᵢ²wᵢ,0) for all SNPs j (13)

This process continues until all weights are equal to zero. When SNPs with maximum weight are tied (as occurs for the first SNP processed), the SNP with lowest genomic coordinate is selected to ensure reproducibility; we have ensured that this method is robust to other methods for breaking ties, including random selection. For simplicity, the correlations are not updated (the update rule would be Cⱼₖ←max[Cⱼₖ−CⱼᵢCₖᵢ/wᵢ,0]), which may lead to an overestimate for T. Model selection may therefore have a conservative bias. The p-values are not affected, however, because they are calculated by permutation tests as described below.

The effective number of tests implies a trivial renormalization of the model prior, (Eq. 5) that does not affect the test statistic. Letting T be the total number of markers, N be the effective number tests, and K be the size of the model, our prior gives each model of size K the weight [(N+1)C(N,K)]⁻¹. If N and T are identical, there are C(N,K) models of this size, and the total weight of all models of size K is 1/(N+1). Since K can range from 0 to N, the sum is normalized. But when T is larger than N, the sum of all models of size K is C(T,K)/(N+1)C(N,K), which is ≧1/(N+1). The sum from k=0 to T is therefore ≧(T+1)/(N+1)≧1. A normalization of 1 can be recovered by including an overall normalization factor, Q=(N+1)⁻¹Σ_{K=0}^{N}C(T,K)/C(N,K). The explicit prior for models of size K is Pr(K)=[Q(N+1)C(N,K)]⁻¹, which is normalized to 1. Since Q is model-independent, it does not contribute to the test statistic.

P-values and genome-wide significance. Two stages of permutation tests are used in the GWiS methods of the present invention: the first stage converts the GWiS test statistic into a p-value that is uniform under the null; the second stage establishes the p-value threshold for genome-wide significance.

The first stage is conducted gene-by-gene. The trait array is permuted using the Fisher-Yates shuffle algorithm, and use the permuted trait to calculate the test statistics using the same procedure as for the original trait. Specifically, the model size K is optimized independently for each permutation, with most permutations correctly choosing K=0. For S successes (log-likelihoods greater than or equal to the unpermuted phenotype data) out of Q permutations, the empirical p-value is S/Q. To save computation, permutations are ended when S≧10. Furthermore, once a finding is genome-wide significant, there is no practical need for additional permutations. For gene-based tests (GWiS, minSNP-P, BIMBAM, and VEGAS), the p-value for genome-wide significance depends on the number of genes tested (rather than the number of SNPs), P≦10⁻⁵ for humans. We therefore also terminate permutations after Q=1 million trials, regardless of S. In these cases, for purposes of ranking, a parametric p-value is estimated for GWiS as

P[F(SSM/SSE,K,T−K−1)]×C(T,K) (14)

The first factor is the parametric p-value for the F statistic from the MLE fit, and the second term is the combinatorial factor for the number of possible models of the same size.

While these p-values are uniform under the null, the threshold for genome-wide significance requires a second set of permutations. To establish genome-wide significance thresholds, in the second stage the ARIC phenotype for each trait was permuted 100 times, ran GWiS for the permuted phenotypes on the entire genome, and recorded the best genome-wide p-value from each of the 100 permutations. The results from each trait were then combined to obtain an empirical distribution of the best genome-wide p-value under the null. The p=0.05 genome-wide significance threshold was then estimated as the 15th best p-value of the 300. This procedure was performed for GWiS, minSNP, minSNP-P, LASSO, and VEGAS to obtain genome-wide significance thresholds for each. Since minSNP-P and BIMBAM are both uniform under the null, we used the genome-wide significance threshold calculated for minSNP-P, 3×10⁻⁶, for BIMBAM to avoid additional computational cost (Table 2). The threshold for GWiS is more stringent, 2×10⁻⁶, presumably because of the locus merging procedure described below. Changes in the genome-wide significance thresholds of up to 50% would not affect any of the reported results.

Hierarchical analysis of genetic loci. In a region with a strong association and LD, GWiS can generate significant p-values for multiple genes in a region. A hierarchical version of GWiS is used to distinguish between two possibilities. First, through LD, a strong association in one gene may cause a weaker association signal in a second gene. In this case, only the strong association should be reported. Second, the causal variant may not be localized in a single gene; for example, the best SNP tags are assigned to multiple genes. In this case, the individual genes should be merged into a single associated locus. The hierarchical procedure is as follows.
1. Identify all genes with CiWiS p≦0.01, and use transitive clustering to merge into a locus all genes whose transcript boundaries are within 200 kb.
2. Run GWiS on the merged locus (including a recalculation of the number of effective tests within the locus) and identify the SNPs selected by the GWiS model. If genes at either end of the locus have no GWiS SNPs, trim these genes from the locus. Repeat this step until no more trimming is possible. If only a single gene remains, accept it with its original p-value as the only association in the region. Otherwise, proceed to step 3.
3. Use a permutation test to calculate the p-value for the merged locus from step 2. Assign it a p-value equal to the minimum of the p-values from the individual genes, and the p-value from its own permutation. Regardless of the p-value used, retain the entire trimmed region as an associated locus.

The trimming in step 2 handles the first possibility, a strong association in one gene that causes a weaker association in a neighbor. The rationale for accepting the smallest p-value in step 3 is the case of a single SNP assigned to multiple genes. The merged region will have a less significant p-value than any single gene, and it does not seem reasonable to incur such a drastic penalty for gene overlap.

Univariate tests: minSNP and minSNP-P. For these tests, SNPs are assigned to gene regions as before. The p-value for each SNP is then calculated using the F-statistic as the test statistic, with empirical p-values from permutation to ensure correct p-values for SNPs with low minor allele frequencies. The minSNP method assigns a gene the p-value of its best SNP. Selection of the best p-value out of many leads to non-uniform p-values under the null. It is standard to reduce this bias by scaling p-values by a Bonferroni correction based on the number of SNPs or number of estimated tests. Instead, we perform gene-by-gene permutation tests using the best F statistic for SNPs within the gene as the test statistic. As with GWiS, if 1 million permutations do not lead to one success, the association is clearly genome-wide significant and we use the Bonferroni-corrected p-value for ranking purposes.

BIMBAM. The Bayesian Imputation-based Association Mapping (BIMBAM) is a Bayesian gene-based method. BIMBAM calculates the Bayes Factor for a model and then averages the Bayes Factors for all models within a gene to obtain a test statistic. Because 1-SNP models were found to have as much power as 2-SNP models, and because 2-SNP models are not computationally feasible for genome-wide analysis, BIMBAM by default restricts its sum to all 1-SNP models within a gene. The Bayes Factor BF(i) for a single SNP

$$iis \\ \begin{matrix}BF ( i ) = Pr ( Y \vert X ) / Pr ( Y ) \\ = {\vert Ω \vert}^{1 / 2} {N}^{1 / 2} {{σ}_{a}^{- 1} [ \frac{{Y}^{′} Y - {B}^{′} {Ω}^{- 1} B}{{Y}^{′} Y - N {\overline{Y}}^{2}} ]}^{- N / 2} .\end{matrix} \qquad ( 15 )$$

The design matrix X has first column ls and second column equal to the dosages of SNP i in the N individuals; Y is the phenotypic mean; Ω=(τ+X′X)⁻¹; the matrix τ is diagonal with diagonal terms (0, σₐ⁻²); and B contains the regression coefficients B=ΩX′Y. We used the recommended value σ_{α}=0.2 relative to the phenotypic standard deviation. The test statistic for a gene with T SNPs is T⁻¹Σᵢ₌₁^{T}BF(i). As with other methods, we used gene-by-gene permutations to convert this statistic into a p-value that is uniform under the null. Up to 1 million permutations were used, stopping after 10 successes.

The sufficient statistics used by BIMBAM are identical to minSNP and minSNP-P, yet we found that the runtime of the public implementation was much slower, taking 270 sec for 1000 permutations of a gene with 135 SNPs across 8000 individuals. By improving memory management and optimizing computations, we improved the timing to 14 sec per 1000 permutations, a 19-fold speed-up.

VEGAS. The Versatile Gene-Based Test for Genome-wide Association (VEGAS) is a recently proposed method that considers the SNPs within a gene as candidates for association study. VEGAS assigns SNPs to each of the autosomal genes using the UCSC genome browser hg18 assembly. The gene boundaries are defined as ±50 kb of the 5′ and 3′ UTRs. Single SNP p-values are used to compute a gene-based χ² test statistic for each gene and significance of each gene is evaluated using simulations from a multivariate normal distribution with mean 0 and covariance matrix being the pairwise LD values between the SNPs from HapMap Phase 2. As a result the method avoids permutations in calculating per gene p-values, although permutations are required to obtain the genome-wide significance threshold.

LASSO regression. LASSO regression is a recent method for combined model selection and parameter estimation that maps L1 regularized regression onto a computationally tractable quadratic optimization problem. Applications to GWAS are attractive because it is possible to perform model selection on an entire chromosome. We therefore implemented a recent LASSO procedure developed specifically for GWAS (Bioinformatics 25: 714-21 (2009).

To reduce computational cost, univariate p-values are estimated from parametric tests, and gene-based SNPs with p<0.001 are retained (we have confirmed that this computational constraint does not lose any known positive associations). Incremental model selection was performed by Least Angle Regression using the R lars package. The LASSO parameter was determined using 5-fold cross validation. All genes with at least one SNP selected were identified, and selected genes overlapping other selected genes (including flanking regions) were merged into single loci.

As suggested previously, we used the Selection Index to rank genes and as the test statistic for a permutation p-value (plosgenetics.org/article/info %3Adoi %2F10.1371%2Fjournal.pgen.1002177%20-%20 pgen.1002177-Wu2). To obtain the Selection Index, the MLE log-likelihood is calculated for the full model and for a reduced model with a subset of SNPs removed. Twice the log-likelihood difference is interpreted as a χ² statistic, and the Selection Index is defined as the corresponding p-value for a χ² distribution with the number of removed SNPs as the degrees of freedom. Due to the LASSO model selection procedure, the Selection Index is not distributed as a χ² under the null, and permutation tests are used to establish genome-wide significance levels.

Simulations: power. For each true model size of K=1 to 8, we performed a series of simulations by picking 1000 genes from chromosome 1 randomly with replacement, using genotype data from the ARIC population of approximately 8000 individuals. For each gene, we selected K “causal” SNPs that have ice R²<0.5 from regression with other “causal” SNPs within the gene. A gene had to have at least 2K SNPs to be picked for models of size K to ensure enough remaining SNPs after the removal of the causal SNPs to permit a model of the true size.

We attempted to distribute the total population variance explained, V=0.007, equally across the K SNPs. The covariance matrix for the SNPs calculated from the population is denoted Σ, with Σᵢⱼ⁻¹ understood to be (Σ⁻¹)ᵢⱼ. The coefficient bₖ for SNP k in the model was set to

$${b}_{k} = \pm \sqrt{V / {\sum }_{i , j = 1}^{K} {\sum }_{ii}^{1 / 2} {\sum }_{ij}^{- 1} {\sum }_{jj}^{1 / 2}} \cdot {\sum }_{l = 1}^{K} {\sum }_{kl}^{- 1} {\sum }_{ll}^{1 / 2} , \qquad ( 16 )$$

which ensures that var(Xb)=V. The phenotype Y for an individual with genotype row-vector X was then calculated as Y=(X−μ)·b+u\sqrt{1−V}, with μ again the population average of X and u drawn from a standard normal distribution.

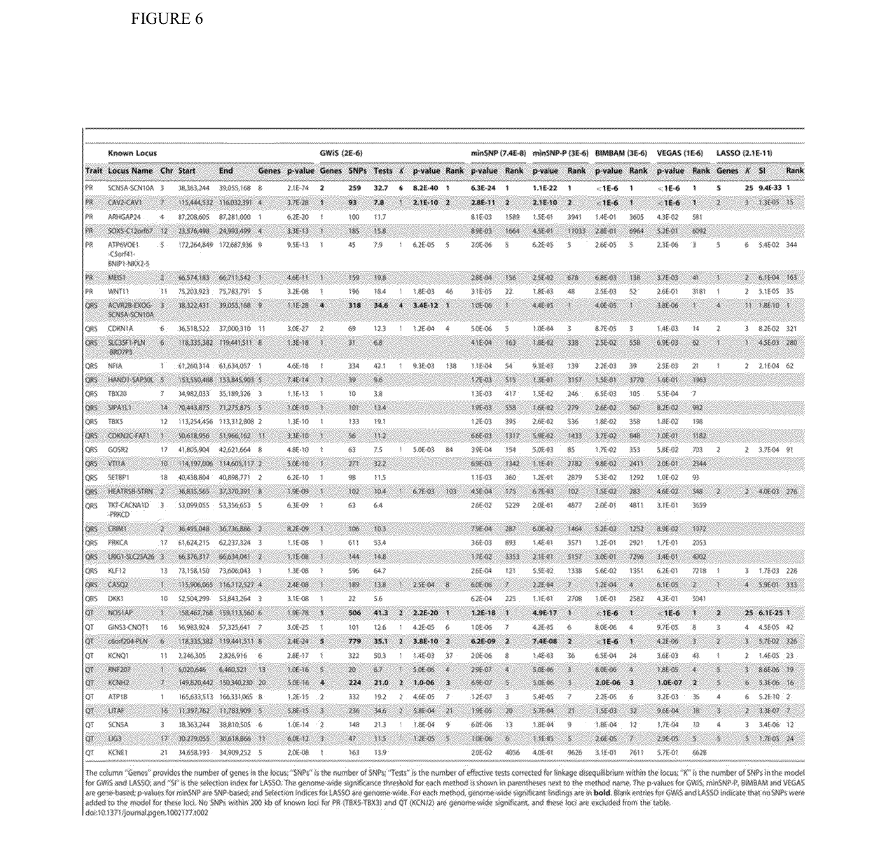

The power was calculated as (number of genes that are genome-wide significant)/1000, and the error of the estimate was calculated using 95% exact binomial confidence intervals. The p-value thresholds were taken directly from genome-wide permutations (FIG. 6).

Simulations: model size. Phenotypes that were used to estimate the model size were generated by assigning each “causal” SNP the same power of 0.1 and 0.8. The population variance explained for each SNP was calculated as V=(z_{α}−z_{1-power})²/N, in which z_{α} is the quantile of the standard normal for upper-tail cumulative probability of α, and z_{1-power} is the quantile for lower-tail probability 1-power. We chose α to be 5×10⁻⁸, the commonly used genome-wide significance threshold for univariate tests. The effect of SNP k is then bₖ=\sqrt{V/Σₖₖ}, in which Σ is the genotype covariance matrix. The simulated phenotypes are then (X−μ)b+u\sqrt{1−KV}, with u drawn from a standard normal distribution. In this test we control for the variance explained by the SNP, not by the gene, and therefore do not rescale the regression coefficients to account for LD. For each K ranging from 0 to 10, we repeated these steps using ARIC genotype data for 100 genes chosen at random from chromosome 1.

Only GWiS and LASSO give model size estimates. GWiS directly reports the model size as the number of independent effects within a gene and LASSO reports the model size as the number of selected SNPs within a gene. We ran both methods using the simulated data with LD. We also tested both scenarios when the causal SNPs were kept or removed from gene.

Performance evaluation. Gene associations were scored as true positives if the gene (or merged locus) overlapped with a known association, and as false positives if no overlap exists. Only the first hit to a known association spanning several genes was counted.

The primary evaluation criterion is the ability to identify known positive associations at genome-wide significance. The genome-wide significance threshold was determined separately for each method (see above), and no method gave any false positives at its appropriate threshold.

A secondary criterion was the ability to enrich highly ranked loci for known associations, regardless of genome-wide significance. This criterion was assessed through precision-recall curves, with precision=TP/(TP+FP), recall=TP/(TP+FN), and true positives (TP), false positives (FP), and false negatives (FN) defined as a function of the number of predictions considered.

Small differences in precision and recall may not be statistically significant. To estimate statistical significance, we performed a Mann-Whitney rank sum test for the ranks of the known associations at 40% recall for GWiS, minSNP, minSNP-P, and LASSO.

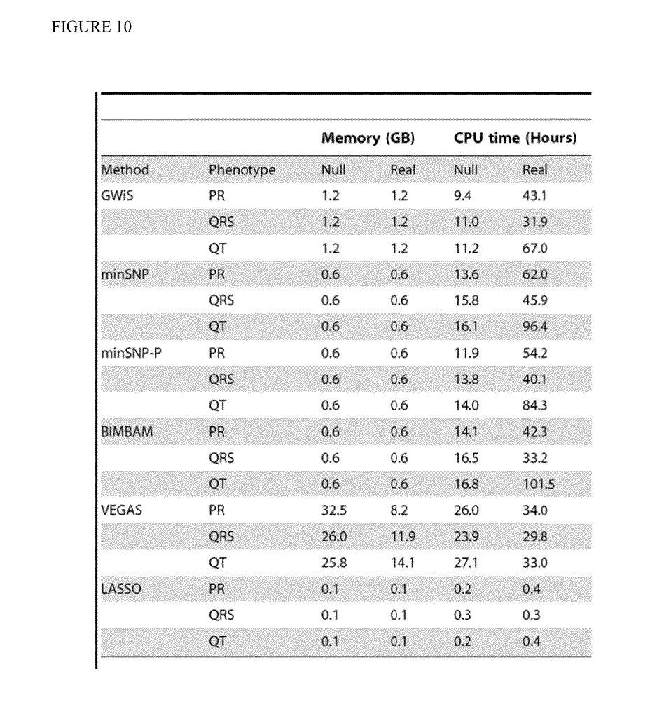

Implementation. GWiS runs efficiently in memory and CPU time, roughly equivalent to other genome-wide tests that require permutations (FIG. 10). Computational times are greater for real data because real associations with small p-values require more permutations. LASSO required far less computational resources, but also pre-filtered the SNPs and had the worst performance. Genome-wide studies can be finished within around 100 hours. Low memory requirements allow GWiS to run in parallel on multiple CPUs. The GWiS source code implementing GWiS, minSNP, minSNP-P, and BIMBAM is available under an open source GNU General Public License as Supplementary Material, also from the inventors' website (baderzone.org), and is being incorporated into PLINK.

### Example 1

Reference genotype and phenotype data. The ECG parameters PR interval, QRS interval and QT interval are ideal test cases because recent large-scale GWAS studies have established known positive associations. These traits are all clinically relevant, with increased PR interval associated with increased risk of atrial fibrillation and stroke, and both increased QRS and QT intervals associated with mortality and sudden cardiac death. The present study assessed the ability of standard methods and the inventive GWiS methods to rediscover these known positives using data from only the Atherosclerosis Risk in Communities (ARIC) cohort, which contributes 15% of the total sample size for QRS, 25% for PR, and 50% for QT (Table 1).

TABLE 1
Populations, genes, and SNP's used in study.

| | PR | QRS | QT |
|---|---|---|---|
| Individuals, published GWAS | 28,517 | 47,797 | 15,842/13,685 |
| Individuals, this study | 7,076 | 7,250 | 7,771 |
| Individuals, this study relative to | 25% | 15% | 49%/57% |
| published | | | |
| Genes, total | 25,251 | | |
| Genes, at least one SNP | 24,337 | | |
| assigned | | | |
| SNPs, total | 2,557,232 | | |
| SNPs, assigned to at least one | 1,392,262 | | |
| gene | | | |
| SNPs, average per gene | 72 | | |
| SNPs, median per gene | 43 | | |
| Effective tests, average per gene | 9.3 | | |
| Effective tests, median per gene | 7.3 | | |

For SNP assignment, gene regions are defined to include 20 kb flanking transcription boundaries.

The SNPs were assigned to genes based on the NCBI Homo sapiens genome build 35.1 reference assembly (Nucleic Acids Res. 37: D5-15 (2009)). Gene boundaries were defined by the most 5′ transcriptional start site and 3′ transcriptional end position for any transcript annotated to a gene, yielding 25,251 non-redundant transcribed gene regions. Incorporating additional flanking sequence increases coverage of more distant regulatory elements, which increases power, but also increases the number of SNPs tested, which decreases power. Expression quantitative trait loci (eQTL) mapping in humans has shown that most cis-regulatory SNPs are within 100 kb of the transcribed region, with quantitative estimates that >93% of large effect eQTNs (functional nucleotides that create eQTLs) are within 20 kb of the transcribed region. We report results for 20 kb flanking regions; the performance ranking is robust to flanking by up to 100 kb. SNPs within these regions are then assigned to one or more genes. Of the approximately 2.5 million genotyped and imputed SNPs, about 1.4 million are assigned to at least one gene. The median number of SNPs per gene is 43 and the mean is 72 (Table 1), reflecting a skewed distribution with many small genes having few SNPs.

The “gold standard” known positives rely on previously published meta-analyses of PR interval (Nat. Genet., 2010 February; 42(2):153-9), QRS interval (Nat. Genet., 2010 December; 42(12):1068-76) and QT interval (Nat. Genet., 2009 41: 407-14; Nat. Genet., 2009 41: 399-406). We first identify gold-standard SNPs having p<5×10⁻⁸. Any gene within 200 kb of a gold-standard SNP is classified as a known positive, and known positives within a 200 kb window are merged into a single locus, yielding 38 known positive gene-based loci. This procedure was followed to ensure that each association signal results in a single locus as opposed to being split between adjacent loci, which could result in over-counting.

Application to ECG data. p-values were then obtained from GWiS, minSNP, minSNP-P, BIMBAM, VEGAS, and LASSO for the ARIC data. Permutations of phenotype data holding genotypes fixed provided thresholds for genome-wide significance for each method (Table 2). Due to LD across genes, a strong signal in one gene can lead to a neighboring gene reaching genome-wide significance. This effect is well known, and scoring these as false positives would unduly penalize traditional univariate tests. Instead, neighboring genes reaching genome-wide significance were merged, and overlap (even partial) with a known positive was scored as a true positive.

TABLE 2
Genome-wide significance thresholds calculated by permutation.

| | 20 kb | 100 kb |
|---|---|---|
| GWiS | 2E−6 | 5E−6 |
| minSNP | 7.4E−6 | 4.7E−8 |
| minSNP-P | 3E−6 | 5E−6 |
| BIMBAM | 3E−6 | — |
| VEGAS | 1E−6 | |
| LASSO | 2.1E−11 | 4.8E−12 |

### Example 2

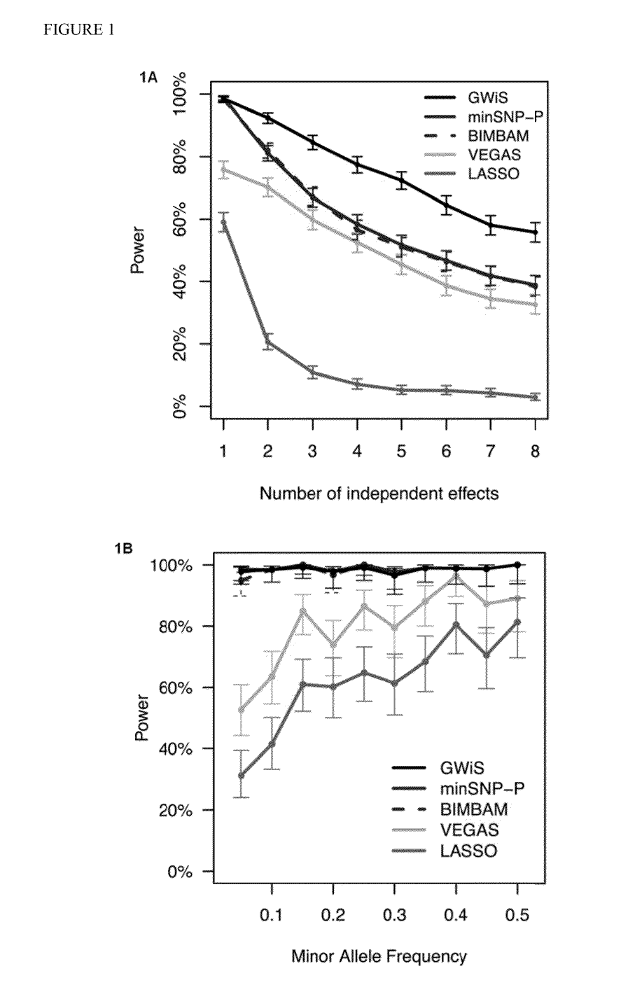

Simulated data and power. Power calculations used genotypes from the ARIC population to ensure realistic LD. Phenotypes were then simulated for genetic models with one or more causal variants within a gene. GWiS was the best-performing method, with an advantage growing as more independent effects are present (FIG. 1A). Theoretically, GWiS should have lower power than single-SNP tests when the true model is a single effect; according to the “no free lunch theorem”, this loss of power cannot be avoided. The performance of GWiS therefore depends on the genetic architecture of a disease or trait: higher power if genes house multiple independent causal variants, and lower power if each gene has only a single causal variant. In practice, the loss of power was so slight as to be virtually undetectable.

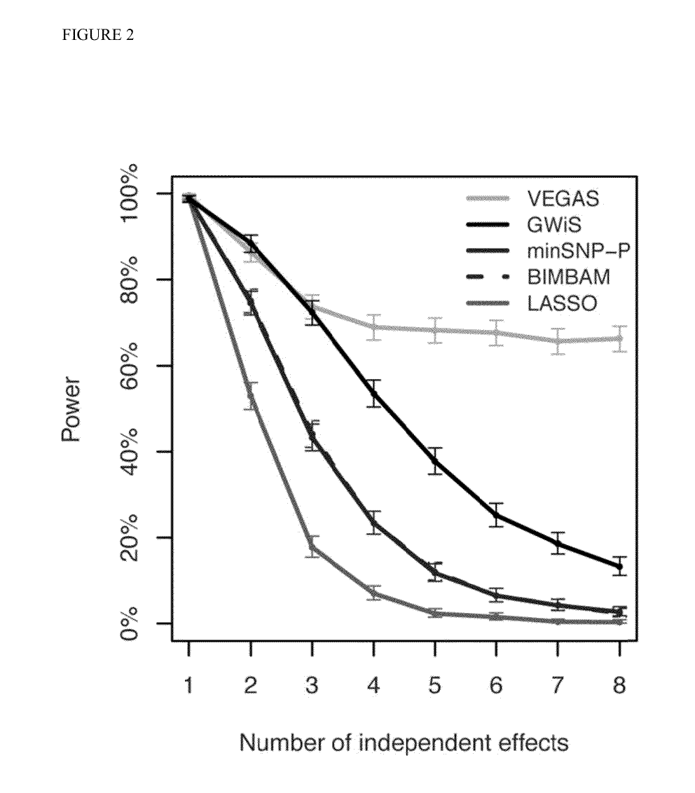

Of the other methods, minSNP-P and BIMBAM had similar performance that degraded as the true model included more SNPs. The VEGAS test did not perform well, presumably because the sum over all SNPs creates a bias to find causal variants in LD blocks represented by many SNPs and to miss variants in LD blocks with few SNPs. In the absence of LD, with genotypes and phenotype simulated using PLINK, VEGAS performs better (FIG. 2). The LASSO method performed worst.

The advantage of GWiS methods of the present invention arises in part from better power to detect associations with low-frequency alleles (FIG. 1B). GWiS, minSNP-P, and BIMBAM have roughly constant power for a given variance explained, regardless of minor allele frequency. In contrast, both VEGAS and LASSO suffer from a two-fold loss of power when minor allele frequencies drop from 50% to 5%. VEGAS may lose power because these low-frequency SNPs lack correlation with other SNPs, reducing the contribution to the VEGAS sum statistic. The LASSO penalty shrinks the regression coefficient, which may adversely affect SNPs with large regression coefficients that balance low minor allele frequencies.

### Example 3

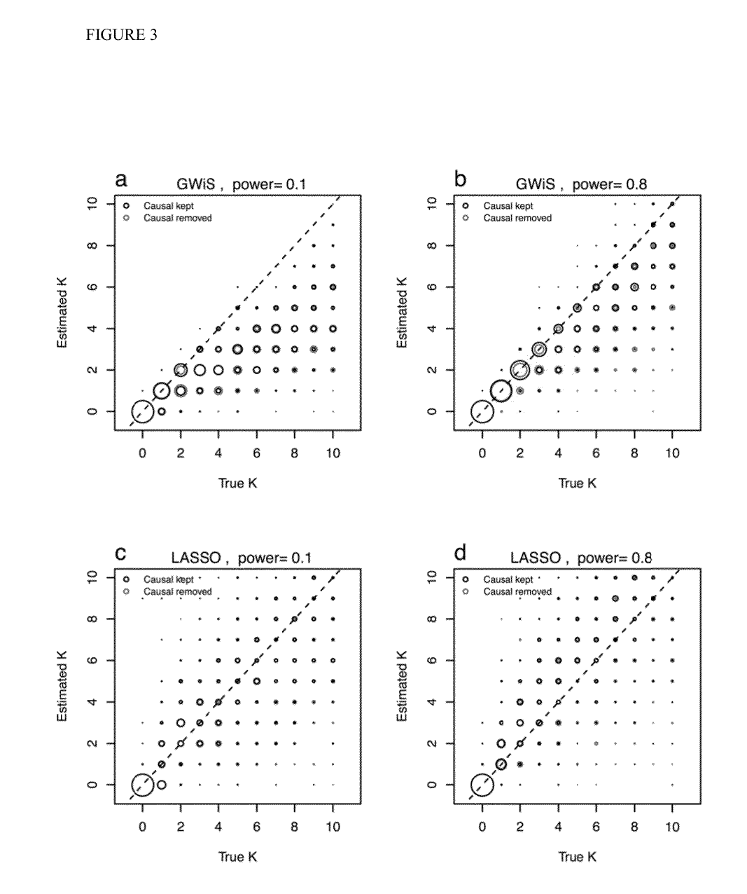

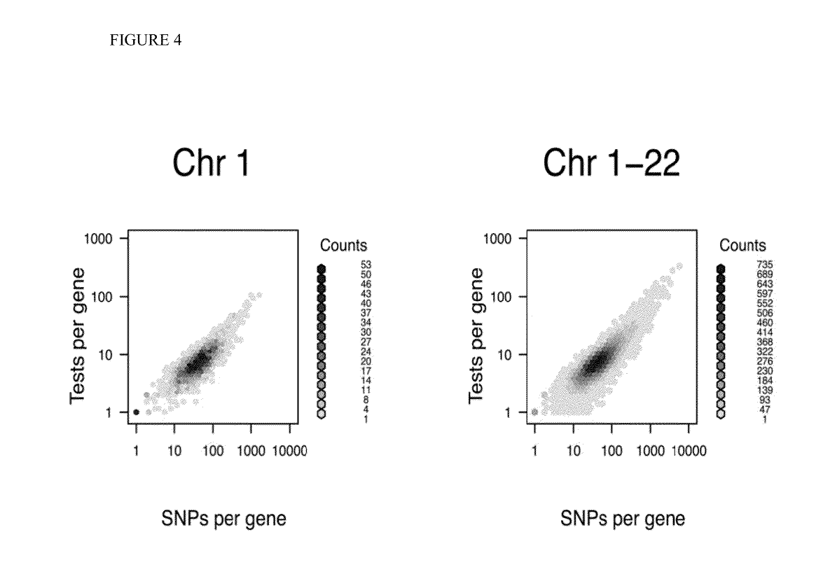

Simulated data and model size. The model size selected by GWiS and LASSO was evaluated by simulation (FIG. 3). These simulations also used the ARIC population to supply realistic LD, with genes selected at random with replacement from chromosome 1. In chromosome 1, the number of SNPs in a gene ranges from 1 to over 1000, and the number of independent effects ranges from 1 to over 100, similar to the distributions in the genome as a whole (FIG. 4). A subset of SNPs within a gene had causal effects assigned (“True K”), phenotypes were simulated to mimic weak and strong gene-based signals, and then models were selected by GWiS and LASSO. Model selection to retain a subset of SNPs (“Estimated K”) was performed both for the full genotype data and for the genotype data with the causal SNPs all removed.

The GWiS methods of the present invention provide a better estimate of the true model size than LASSO, assessed from the R² of estimated versus true K. With causal SNPs kept, R² for GWiS is substantially higher, 0.65 versus 0.47 at low power (FIGS. 3A, 3C) and 0.81 versus 0.60 at high power (D). GWiS also performs better when causal SNPs are removed, 0.55 versus 0.33 at low power and 0.60 versus 0.39 at high power. GWiS also provides a conservative estimate of the model size, with the ratio of estimated to true size ranging from a worst-case of 44% (low power, causal SNPs removed) to a best-case of 81% (high power, causal SNPs kept) over the four scenarios examined. In contrast, LASSO is prone to over-predict the size of the model, with a worst-case of models that are on average 33% too large (high power, causal SNPs kept, FIG. 3D).

Removing a causal SNP results in GWiS predicting a smaller model, with the ratio of estimated to true dropping from 0.55 to 0.44 for low power and from 0.85 to 0.81 for high power. These reductions in model size are highly significant (P<2×10⁻¹⁶ for both, Wilcoxon pair test) and counter a concern that the absence of a causal variant from a marker set will inflate the model size by introducing multiple markers that are partially correlated with the untyped causal variant. These results demonstrate that the model size returned by GWiS is conservative for causal variants with small effects, and approaches the true model size for causal variants with large effects.

### Example 4

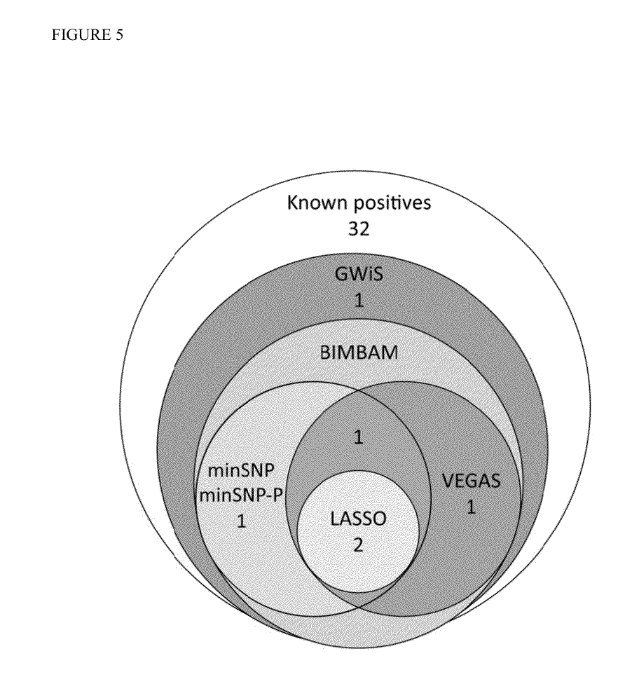

GWiS out-performed all other methods in the comparison (FIGS. 5 and 6). GWiS identifies 6 of 38 known genes or loci as genome-wide significant. In contrast, BIMBAM identifies 5 known positives; minSNP, minSNP-P and VEGAS identify 4; and LASSO identifies 2. Loci identified by the other methods are all subsets of the 6 found by GWiS. None of the methods produced any false positives at genome-wide significance.

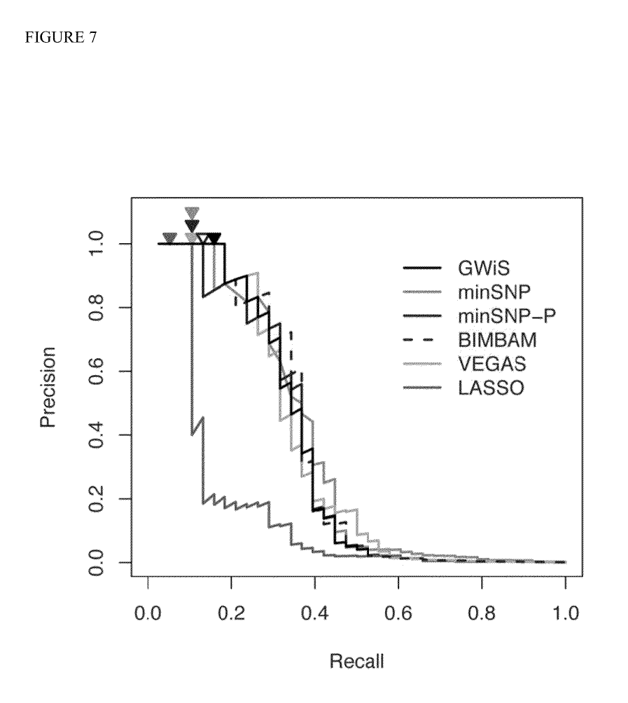

Due to the limited size of the ARIC cohort relative to the studies that generated the known positives, no method was expected to find all 38 known loci to be genome-wide significant. Nevertheless, known positives should still rank high among the top predictions of each method, assessed by the ranks of the known positives at 40% recall (FIG. 7). It was found that GWiS, minSNP, minSNP-P, BIMBAM, and VEGAS were equally effective in ranking known positives (Mann-Whitney rank sum p-values ≧0.78 for any pairwise comparison). LASSO performed below the other methods (p-value ≦0.04 for a pairwise comparison of LASSO to any other method). Top associations (up to 100 false positives) from each method are provided for PR interval, QRS interval, and QT interval (data not shown).

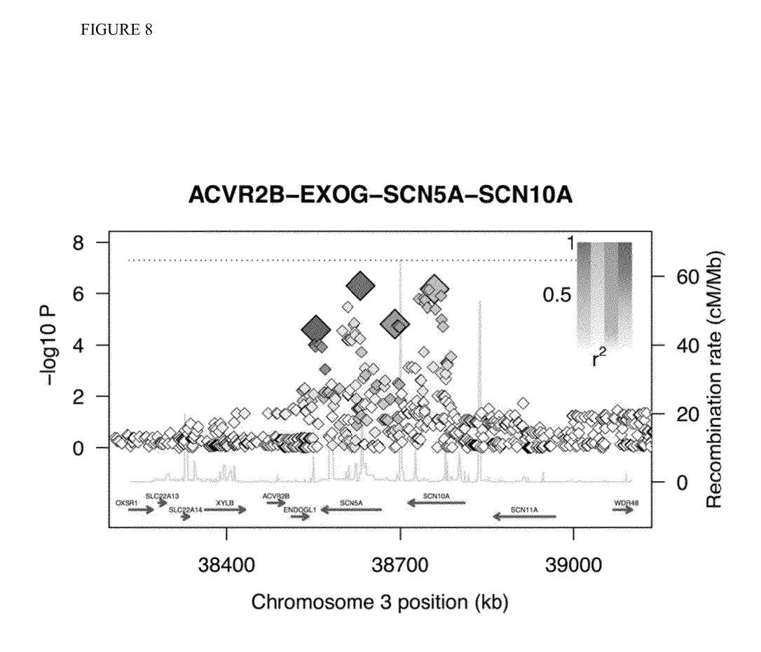

While the conclusions are based on cardiovascular phenotypes, the results show that GWiS has an advantage when causal genes have multiple effects. When an association is sufficiently strong to be found by a univariate test, GWiS methods of the present invention are generally able to identify it. Beyond these associations, GWiS is also able to detect genes that are genome-wide significant, but where no single effect is large enough to be significant by univariate tests. The association of QRS interval with SCN5A-SCN10A is a striking example: 4 independent effects are found by GWiS (p-value=3.4×10⁻¹²) but the association is not genome-wide significant by univariate methods (p-value=4.4×10⁻⁵ for minSNP-P) (FIG. 8). A common follow-up strategy for single-SNP methods is to search for secondary associations in the same locus as a strong primary association. These results for ARIC together with results above for simulated data (FIG. 3) demonstrate that GWiS performs this task well. While this feature is present in previous follow-up methods for candidate loci, it is absent from methods generally used for primary analysis of GWAS data.

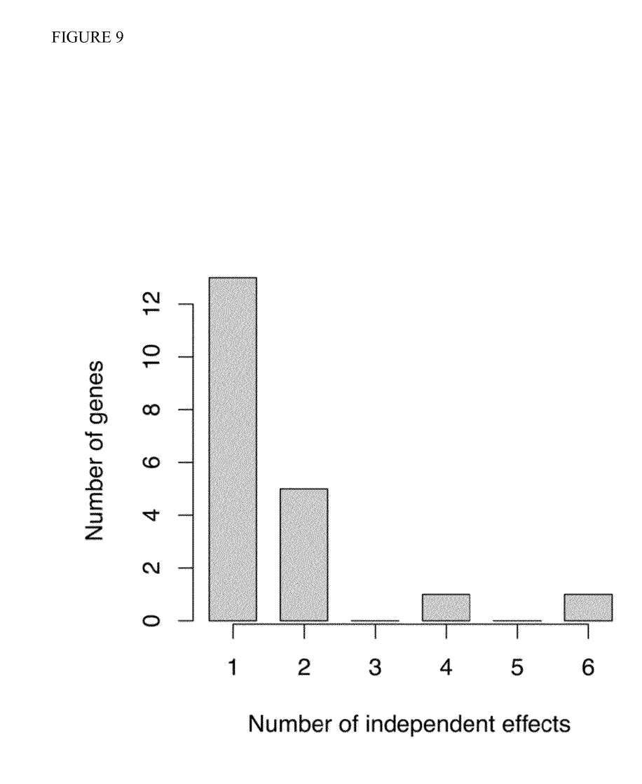

Of the 38 known positives, 20 have GWiS models with at least one SNP (regardless of genome-wide significance), and 7 of these are predicted to have multiple independent effects (FIG. 9). These results suggest that the genetic architecture of ECG traits supports the hypothesis underlying GWiS. Moreover, for QT interval where the power is greatest to identify known positives (the ARIC sample size is 50% of the GWAS discovery cohorts), 5 of the 10 loci identified by GWiS are predicted to have multiple independent effects.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for identifying one or more single nucleotide polymorphisms (SNP) associated with one or more phenotypic traits of interest in a subject comprising:
a) identifying one or more phenotypic traits of interest;
b) mapping known SNPs to the genes in the genome, wherein SNPs located within 20 kb of the transcribed genomic loci are included;
c) calculating for each gene, the GWiS test statistic (greedy forward selection from all single SNPs and pairs) using the GWiS function;
d) calculating for each gene, the null distribution of the test statistics by permutation tests, using the GWiS function;
e) calculating for each gene, GWiS p-value from the null distribution;
f) performing hierarchical analysis of genetic loci identified in b) comprising:
1) identifying all gene loci with GWiS p-value ≦0.01;
2) using transitive clustering to merge into a locus, all gene loci whose transcript boundaries are within 200 kb;
3) calculating the GWiS statistic on the merged locus using the GWiS function;
4) identifying the SNPs selected by 3) wherein
i) if the genes are located at either end of the locus of 2) and have no GWiS SNPs, delete these genes from the locus;
5) repeat steps 3) and 4) until there are no further genes which can be deleted;
6) if only 1 gene remains in the locus, identifying it with its original p-value from step e); otherwise;
if more than 1 gene remains in the locus, use a permutation test to calculate the p-value for the merged locus of 3); and
7) assigning the merged gene locus a p-value equal to the minimum p-values of the individual genes (from e) and the p-value from the merged locus' own permutation (from 6) and retain the entire region as an associated gene locus.

2. The method of claim 1, wherein the phenotypic trait is associated with an organ system of a mammal.

3. The method of claim 2, wherein the phenotypic trait is associated with a disease or condition.

4. The method of claim 3, wherein the disease or condition is cardiovascular disease, cancer, diabetes, stroke, neurological disease, enzymatic deficiencies, alzheimers, parkinsons, galactosemia, thalassemias, neuropathy, immune system disorders, amyotrophic lateral sclerosis, hypercholestermia, autism, schizophrenia, Crohn's disease, and ulcerative colitis.

5. The method of claim 4, wherein the one or more SNPs identified are used to generate a SNP database.

6. A database containing one or more SNPs identified using the methods of claim 4.

7. A computer system comprising: a relational database having records containing a) information about one or more SNPs identified using the methods of claim 4; b) information identifying known SNPs to the genes known to be associated with the one or more phenotypic traits of interest; and c) a user interface allowing a user to selectively access the information contained in the records.

8. A computer program product comprising: a computer-usable medium having computer-readable program code embodied thereon relating to generating a relational database having records containing a) information about one or more SNPs identified using the method of claim 4; b information identifying known SNPs to the genes known to be associated with the one or more phenotypic traits of interest; wherein one or more SNPs in a) is determined based b) and the method of claim 4.

9. A computerized method for identifying one or more single nucleotide polymorphisms (SNP) associated with one or more phenotypic traits of interest in a subject comprising:
a) receiving, by a computer, the identification of one or more phenotypic traits of interest;
b) mapping by a computer, known SNPs to the genes in the genome, wherein SNPs located within 20 kb of the transcribed genomic loci are included;
c) computing, by the computer, for each gene, the GWiS test statistic (greedy forward selection from all single SNPs and pairs) using the GWiS function;
d) computing, by the computer, for each gene, the null distribution of the test statistics by permutation tests, using the GWiS function;
e) computing, by the computer, for each gene, GWiS p-value from the null distribution;
f) computing, by the computer, hierarchical analysis of genetic loci identified in b) comprising:
1) identifying, by the computer, all gene loci with GWiS p-value ≦0.01;
2) computing, by the computer, using transitive clustering to merge into a locus, all gene loci whose transcript boundaries are within 200 kb;
3) computing, by the computer, the GWiS statistic on the merged locus using the GWiS function;
4) identifying, by the computer, the SNPs selected by 3) wherein
i) if the genes are located at either end of the locus of 2) and have no GWiS SNPs, delete these genes from the locus;
5) repeat steps 3) and 4) until there are no further genes which can be deleted;
6) if only 1 gene remains in a locus, identifying it with its original p-value from step e); otherwise;
if more than 1 gene remains in a locus, use a permutation test to calculate the p-value for the merged locus of 3); and
7) assigning, by the computer, the merged gene locus a p-value equal to the minimum p-values of the individual genes (from e) and the p-value from the merged locus' own permutation (from 6) and retain the entire region as an associated gene locus.

10. A computerized system identifying one or more single nucleotide polymorphisms (SNP) associated with one or more phenotypic traits of interest in a subject comprising:
a) a server and a client connected by a network;
b) an application connected to the server and/or the client by the network, the application configured for:
c) receiving, by a computer, the identification of one or more phenotypic traits of interest;
d) mapping by a computer, known SNPs to the genes in the genome, wherein SNPs located within 20 kb of the transcribed genomic loci are included;
e) computing, by the computer, for each gene, the GWiS test statistic (greedy forward selection from all single SNPs and pairs) using the GWiS function;
f) computing, by the computer, for each gene, the null distribution of the test statistics by permutation tests, using the GWiS function;
g) computing, by the computer, for each gene, GWiS p-value from the null distribution;
h) computing, by the computer, hierarchical analysis of genetic loci identified in
b) comprising:
1) identifying, by the computer, all gene loci with GWiS p-value ≦0.01;
2) computing, by the computer, using transitive clustering to merge into a locus, all gene loci whose transcript boundaries are within 200 kb;
3) computing, by the computer, the GWiS statistic on the merged locus using the GWiS function;
4) identifying, by the computer, the SNPs selected by 3) wherein
i) if the genes are located at either end of the locus of 2) and have no GWiS SNPs, delete these genes from the locus;
5) repeat steps 3) and 4) until there are no further genes which can be deleted;
6) if only 1 gene remains in a locus, identifying it with its original p-value from step e); otherwise;
if more than 1 gene remains in a locus, use a permutation test to calculate the p-value for the merged locus of 3); and
7) assigning, by the computer, the merged gene locus a p-value equal to the minimum p-values of the individual genes (from e) and the p-value from the merged locus' own permutation (from 6) and retain the entire region as an associated gene locus.
